(19) United States
(12) Patent Application Publication
(10) Pub. No.: US 2024/0258625 A1
(43) Pub. Date: Aug. 1, 2024

(54) Structural Element for a Battery Housing of an Electrically Drivable Motor Vehicle

(71) Applicant: Bayerische Motoren Werke Aktiengesellschaft, Muenchen (DE)

(72) Inventors: Ahmed EL-SAWY, Muenchen (DE); Peter ROESCH, Muenchen (DE)

(21) Appl. No.: 18/290,854

(22) PCT Filed: Jul. 20, 2022
(86) PCT No.: PCT/EP2022/070293

§ 371 Date: Jan. 22, 2024

(30) Foreign Application Priority Data
Jul. 23, 2021 (DE) 10 2021 119 157.2

(51) Int. Cl. H01M 50/242; B60L 50/64; H01M 50/224; H01M 50/249

(52) U.S. Cl. CPC H01M 50/242; B60L 50/64; H01M 50/224; H01M 50/249; H01M 2220/20

(57) ABSTRACT

A structural element for a battery housing of a motor vehicle is located, in the longitudinal direction of the vehicle, in an end region of the battery housing. In order to improve the properties of the battery housing in the event of an accident, the structural element includes at least one deformation zone for specific deformation and energy absorption, the at least one deformation zone having at least two interconnected wall portions which extend in the vertical and transverse directions of the vehicle and between which a free space is formed.

### BACKGROUND AND SUMMARY

The invention relates to a structural element for a battery housing of an electrically drivable motor vehicle.

A battery housing for underfloor fastening to a passenger motor vehicle is already known, for example, from DE 10 2017 111 021 A1. In this case, respective structural elements of the battery housing are arranged on its lateral longitudinal sides and on the front side and rear side.

Specifically in the case of a frontal collision of the motor vehicle with a small width overlap with a counterparty in the accident or a barrier (offset crash), there is frequently the problem that the structural element arranged at the front end region of the battery housing in the longitudinal direction of the vehicle is subjected to considerable forces. These forces originate, for example, from the respective attachment struts via which the structural element and therefore the battery housing are connected to a front axle support. Specifically in the case of such a frontal impact described, the structural element, due to accident-induced rear shifting of the struts serving to connect the front axle support to the battery housing, is subjected, under some circumstances, to a considerable force such that intrusions into the battery housing may occur in the region of the attachment points of the respective struts to the structural element. In the worst case, this may result in a thermal event within the energy store arranged in the battery housing.

It is therefore the object of the present invention to provide a structural element of the type mentioned, by means of which the accident properties of the battery housing can be improved.

This object is achieved according to the invention by a structural element having the features of the independent claims. Advantageous developments are the subject matter of the dependent claims.

The structural element according to the invention is arranged—extending at least substantially horizontally and in the transverse direction of the vehicle—at a front or rear end region of the battery housing in the longitudinal direction of the vehicle. To improve the accident properties of the battery housing, it is provided here according to the invention that the structural element has at least one deformation region for targeted deformation and energy absorption, the deformation region having at least two at least indirectly interconnected wall regions which run in the vertical direction of the vehicle and in the transverse direction of the vehicle and between which a clearance is formed. Accordingly, the at least two wall regions running in the vertical direction of the vehicle and in the transverse direction of the vehicle delimit the respective clearance on the front side or on the rear side. By means of the at least indirectly connected wall regions running in the vertical direction of the vehicle and in the transverse direction of the vehicle, the deformation region can thus be specifically coordinated in such a manner that it can be used for deformation and energy absorption in the event of an accident-induced application of force. In the event of an accident-induced introduction of force, the two wall regions are therefore pushed counter to each other or onto each other, with deformation and energy absorption of the corresponding deformation region, in order to absorb the introduced energy.

The structural element according to the invention therefore creates the possibility of being able to absorb

forces or energy introduced into the structural element due to an accident, or to deform the structural element, in such a manner that as far as possible no intrusion into the battery housing which is arranged in an underfloor arrangement under the body of the passenger vehicle can occur. By this means, in particular a thermal event in the energy store can be avoided.

Such an introduction of accident forces occurs for example and in particular if the motor vehicle has a frontal collision with a small width overlap with the counterparty in an accident or a barrier such that, for example, respective struts which connect the structural element arranged at the front end region of the battery housing to a front axle support are displaced to the rear in the longitudinal direction of the vehicle so that force is correspondingly applied to the structural element. By means of the deformation region of the structural element, it should therefore be avoided in particular according to the invention that excessive intrusion into the battery housing of the motor vehicle occurs.

It should be noted at this juncture that the present structural element can be arranged not only on the front side of the battery housing and provided for mitigating a frontal collision, but that it would also be conceivable to provide such a structural element at the rear end of the battery housing for protection against a rear-end collision.

In a further advantageous embodiment of the invention, the clearance is open toward a lower side or an upper side of the structural element. This has the advantage in particular that additional energy absorption structures, for example ribs or the like, which can be produced in a simple manner can be provided within the clearance.

In this connection, it has been shown to be further advantageous if in the clearance a plurality of ribs or similar supporting elements are provided, by means of which the two interconnected wall regions running in the vertical direction of the vehicle and in the transverse direction of the vehicle are supported in the longitudinal direction of the vehicle. The respective ribs or similar supporting elements can therefore make it possible to adjust the deformation and energy absorption capability of the deformation region of the structural element in an advantageous manner.

In a further advantageous refinement of the invention, the two wall regions running in the vertical direction of the vehicle and in the transverse direction of the vehicle are interconnected via a connecting wall region to form a cross-sectionally substantially U-shaped wall region. By this means, the connecting wall region additionally serves for deformation and energy absorption of the deformation region of the structural element.

In a further advantageous embodiment of the invention, at least one further wall region running in the vertical direction of the vehicle and in the transverse direction of the vehicle is provided, which, together with the adjacent one of the two wall regions running in the vertical direction of the vehicle and in the transverse direction of the vehicle, forms a respective further clearance. As a result, a plurality of clearances divided from one another by respective wall regions can therefore be created in the deformation region in order to adjust the deformation and energy absorption in the region of the deformation region.

In this connection, it has been shown to be further advantageous if the at least one further wall region running in the vertical direction of the vehicle and in the transverse direction of the vehicle is connected to the adjacent one of the two wall regions running in the vertical direction of the vehicle and in the transverse direction of the vehicle via a further connecting wall region to form a cross-sectionally substantially U-shaped wall assembly. Current U-shaped wall assemblies have been shown to be particularly advantageous in respect of the deformation and energy absorption.

In a further refinement of the invention, the wall regions running in the vertical direction of the vehicle and in the transverse direction of the vehicle extend at least approximately over the entire width of the structural element. This not only makes particularly advantageous production of the structural element and/or of the deformation region possible, but moreover makes possible an advantageous energy absorption capability of the structural element over the at least approximately entire width of the battery housing.

A structural element functioning particularly simply and nevertheless highly effectively can be formed by the structural element being produced from a metal casting, for example a metal diecasting.

In a further advantageous embodiment of the invention, the structural element has respective attachment points for an axle support and/or a bodyshell element of the motor vehicle body on the outside of the clearance in the longitudinal direction of the vehicle. Accordingly, the structural element or the battery housing can be connected in the region of the attachment points not only to an axle support in the above-described way, but also, for example, can be connected to bodyshell elements arranged in particular on the upper side of the battery housing or of the structural element, such as transverse supports or longitudinal supports of the motor vehicle body.

Finally, it has been shown to be advantageous if the structural element is arranged on a front side of the battery housing since, specifically in the event of frontal collisions, in particular with a small width overlap of the vehicle with an accident partner or an obstacle, the risk of considerable applications of force to the structural element or the battery housing is particularly high.

The invention will now be explained in more detail using a preferred exemplary embodiment and with reference to the drawings.

### BRIEF DESCRIPTION OF THE DRAWINGS

FIG. 1 is a top view of a lower housing part of a battery housing of an electric drive of a passenger motor vehicle with a structural element according to an embodiment of the invention arranged at the front end region of the battery housing;

FIG. 2 is a top view of the structural element at the front end region of the battery housing according to FIG. 1;

FIG. 3 is a perspective sectional view through the structural element according to FIG. 2;

FIG. 4 is a sectional view through the structural element according to FIGS. 2 and 3; and

FIG. 5 is a perspective and sectioned bottom view of the structural element according to FIGS. 2 to 5.

### DETAILED DESCRIPTION OF THE DRAWINGS

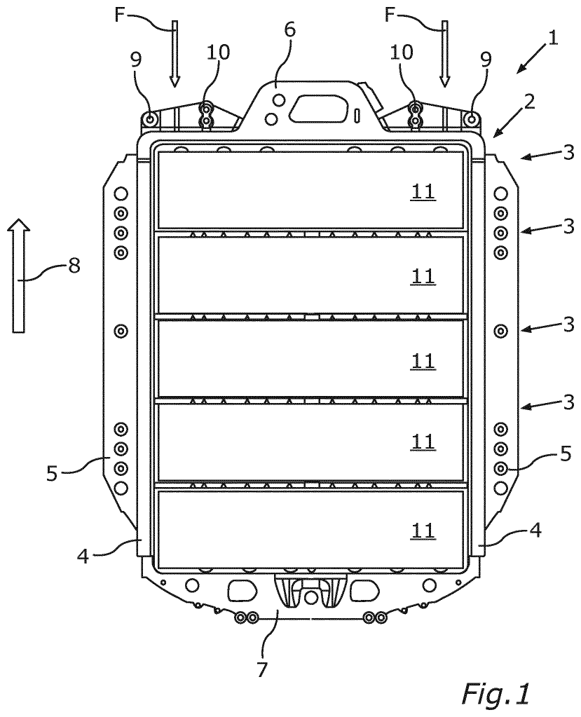

In FIG. 1, a lower housing part 1 of a battery housing for an electric drive of a motor vehicle, in particular a passenger motor vehicle, can be seen in a top view. The lower housing part 1 is connected, for example, in a conventional manner to an upper housing part, not visible, in order to form the least substantially closed battery housing. Of course, it would also be conceivable in this connection to fasten the lower housing part 1 on the underside of the vehicle floor, wherein the lower housing part or the vehicle floor forms the upper housing part of the battery housing. In the present case, the lower housing part 1 and the upper housing part of the battery housing are divided from one another along a substantially horizontal section plane running in the transverse direction of the vehicle and longitudinal direction of the vehicle, and are connected to each other by suitable sealing and connecting technology, for example.

In the present case, the lower housing part 1 comprises a frame structure 2 with respective transverse supports 3 and longitudinal supports 4. The longitudinal supports 4 comprise respective structural elements 5 which serve, for example, for fastening respective laterally corresponding side sills on the underside and are formed either in one part or multiple parts with the corresponding longitudinal supports 4.

A respective structural element 6, 7 is provided as a transverse support 3 at the front and rear end region of the lower housing part 1 and therefore also of the battery housing. These structural elements 6, 7 accordingly likewise form part of the frame structure 2 and of the lower housing part 1 of the battery housing.

A forward direction of travel of the motor vehicle is indicated here by an arrow 8, and therefore it can be seen that the structural element 6 is arranged at the front end region 1 of the battery housing.

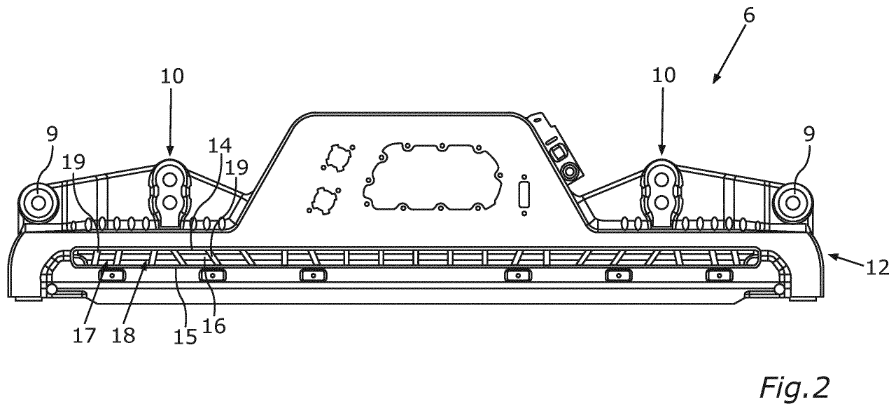

This structural element 6 is illustrated separately and in enlarged form in FIG. 2, wherein in particular respective attachment points 9, 10 are illustrated, by means of which the structural elements 6 and therefore the lower housing part 1 or the battery housing are connected, in particular bolted, on the one hand, to respective longitudinal or transverse members of the motor vehicle body floor structure arranged above, and by means of which, on the other hand, the structural element 6 or the lower housing part 1 and the battery housing are connected via struts, not visible, to a front axle support of a front axle of the passenger motor vehicle.

If, for example, a frontal collision of the motor vehicle with an accident partner or an obstacle with a small width overlap, what is referred to as an offset crash, occurs, accident-induced forces are introduced considerably at these attachment points 9, 10, for example via the attachment struts of the front axle support or else via the attachment points to the motor vehicle body. This is in particular due to the fact that, in the event of such a frontal collision with a small width overlap, the respective axle members of the front axle support are subjected to considerable forces, and therefore the considerable forces are transmitted to the structural element 6 via the connecting struts of the structural element 6 to the front axle support. In FIG. 1, arrows F symbolize the introduction of the respective forces into the structural element 6 of the lower housing part 1 or of the battery housing of the high-voltage store in the event of such an outlined frontal crash.

In FIG. 1, the high-voltage store accommodates a plurality of cell modules 11 in a transverse arrangement within the lower housing part 1 within the battery housing.

In order in this case to avoid a thermal event as a result of excessive intrusion into the battery housing, the structural element 6 has a deformation region which will be explained further below.

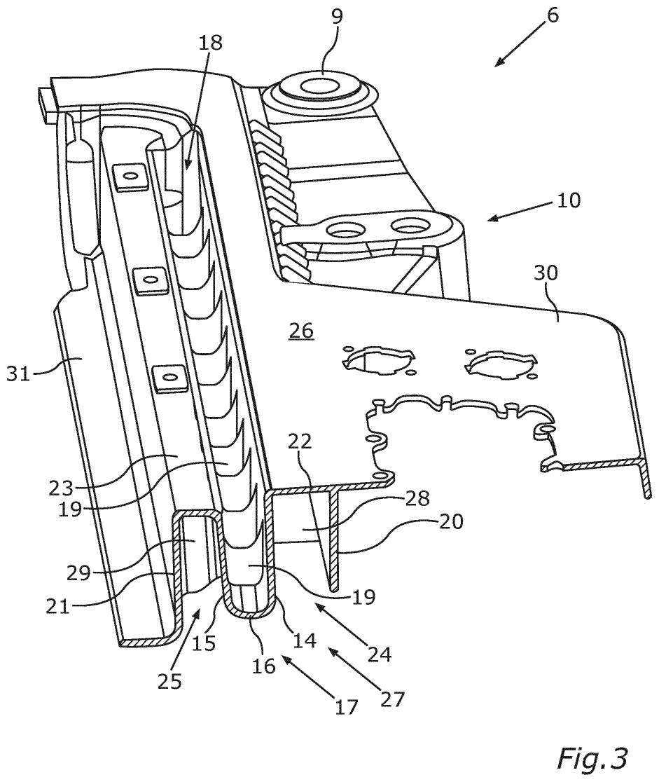

As can be seen in particular from FIG. 3, which shows the structural element 6 in a perspective sectional view along a sectional plane running in the center plane of the vehicle in the longitudinal direction of the vehicle and in the vertical direction of the vehicle, the deformation region 12 is provided which firstly comprises two wall regions 14, 15 which run in the vertical direction of the vehicle and in the transverse direction of the vehicle over approximately the entire width of the structural element 1, run with one another and are indirectly connected to one another via a connecting wall region 16 such that overall a cross-sectionally substantially U-shaped wall assembly 17 is formed which delimits a clearance 18. As can be seen from FIGS. 2 and 3, this clearance 18 is open toward an upper side 19 of the structural element 6, which at the same time forms the separating plane of the lower housing part 1 from the upper housing part, not shown. Accordingly, the clearance 18 according to FIGS. 2 and 3 can be seen as a duct which is open from above.

It can furthermore be seen from FIGS. 2 and 3 that within the clearance 18 a plurality of ribs 19 or similar supporting elements are arranged which are connected to the wall regions 14, 15 and to the connecting wall region 16. These ribs 19 accordingly serve in particular for supporting the wall regions 14, 15 running in the vertical direction of the vehicle and in the transverse direction of the vehicle, wherein in particular the deformation and energy absorption behavior of the deformation region 12 of the structural element 6 can be adjusted by these ribs 19.

In the present exemplary embodiment, the structural element 6 is designed as a metal cast component, for example as an aluminum diecast component or as a steel cast component. Accordingly, in the present case, the ribs 19 are integrally connected with the wall regions 14 and 15 or the connecting wall regions 16. Accordingly, the open conFiguration of the clearance 18 also results in a particularly advantageous removal of the ribs 19 from a mold.

With reference to the two wall regions 14, 15 which each extend in the transverse direction of the vehicle and in the vertical direction of the vehicle, two further wall regions 20, 21 extending in the vertical direction of the vehicle and in the transverse direction of the vehicle are provided, which wall regions are connected to one another via a respective connecting wall region 22 or 23. The respective connecting wall regions 22, 23, in the same manner as the connecting wall region 16, run at least substantially horizontally and in the transverse direction of the vehicle. By means of the respective wall regions 20, 21 in conjunction with the respectively adjacent wall regions 14, 15, which likewise run in the vertical direction of the vehicle and in the longitudinal direction of the vehicle, two further clearances 24, 25 are created which adjoin the clearance 18 on the front side or on the rear side and, in contrast to the clearance 18, are not open toward the upper side 26 of the structural element 6, but rather, on the contrary, to the lower side 27 thereof.

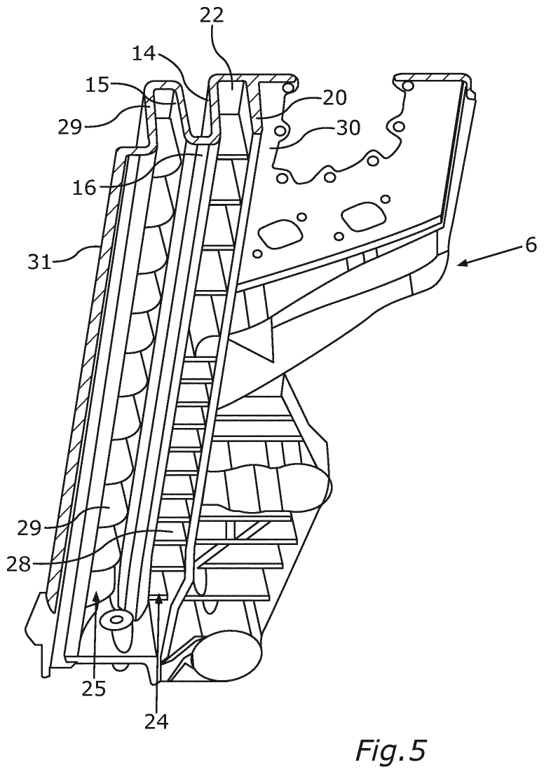

It can be seen in particular in an overview with FIG. 5, which shows the structural element 6 in a further perspective sectional view obliquely from below at a viewing angle which is changed in relation to FIG. 3, that respective ribs 28, 29 are also provided within the respective clearances 24, 25, the ribs extending between the respective wall regions 20, 21 running at least substantially in the vertical direction of the vehicle and in the transverse direction of the vehicle and upward as far as the respective connecting wall region 22, 23. Here too, a suitable shape and number or configuration of the respective ribs 28, 29 makes it possible to adjust the deformation capability and energy absorption capability of the deformation region 12 of the structural element 6. It can also be seen here that the clearances 24, 25 extend in the transverse direction of the vehicle at least substantially over the entire width of the structural element 6 or of the battery housing. It is clear that not each of the clearances 18, 24, 25 of increasing sizes has to have ribs 19. Depending on the configuration of the deformation region 12 of the structural element 6, it is also possible for only some of the clearances 18, 24, 25 to be provided with corresponding ribs 19. It is also conceivable for the respective ribs 19, 28, 29 to be supported only toward one wall region 14, 15, 20, 21 in each case.

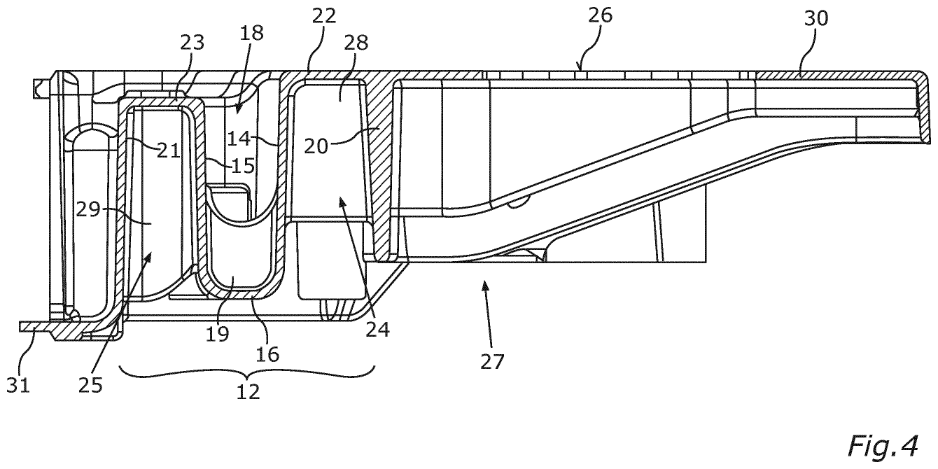

FIG. 4 once again shows the cross section of the structural element 6 in a sectional view along a sectional plane running in the vertical direction of the vehicle and in the longitudinal direction of the vehicle. In this case, in particular the meandering configuration of the wall regions 14, 15, 16 and 20, 21, 22, 23 which form the three clearances 25, which are open towards the respective upper side 26 or lower side 27 of the structural element 6, become clear. In the present case, the deformation region 12 accordingly extends between the frontmost wall region 20 running in the longitudinal direction of the vehicle or in the vertical direction of the vehicle and the rearmost wall region 21 running in the vertical direction of the vehicle or in the transverse direction of the vehicle. This is symbolized in FIG. 4 by a corresponding bracket.

The frontmost wall region 20 or wall region 22 is forwardly adjoined by a further wall region 30 of the structural element 6 which serves in the present case, for example, for bearing against the housing upper part. The rearmost wall region 21 running in the vertical direction of the vehicle or in the transverse direction of the vehicle is adjoined by a rear wall region 31 in the transverse direction of the vehicle, which is adjoined by a cover element of the lower housing part 1, the cover element filling or downwardly closing the respective compartments of the frame structure 2.

In an overall view of FIGS. 1, 2 and 3, it can also be seen that the wall region 31 and the connecting wall region 21 form a boundary to which the frontmost cell module 11 is adjacent. Accordingly, the deformation region 12 is arranged on the front side of the frontmost cell module 11 and therefore serves for protecting in particular this cell module 11 and also the remaining cell modules 11 which form the high-voltage store within the battery housing.

In addition, it can be seen particularly readily in particular from FIGS. 2 and 3 that the respective attachment points 9, 10 of the structural element for the front axle support or for attaching the battery housing to bodyshell-side structural elements are arranged on the front side of the deformation region 12 of the structural element 6. Accordingly, forces introduced into the structural element 6 according to the arrows F are optimally admitted into the deformation region 12 and absorbed there by corresponding deformation and energy absorption.

Overall, it therefore becomes clear that the targeted energy dissipation in the integral cast component means that loads from the front crash are not transmitted to the cell modules 11.

The energy is dissipated here in the same cast component/structural element 6 which also contains the attachment points 9, 10 to the bodyshell in the front (therefore in the front crash structure). The energy dissipation is realized by targeted deformation of the cast component 6 via predetermined buckling points in the region of the respective U-shaped wall assembly 17. The direct load path is therefore interrupted and no separate components or construction space are necessary.

### LIST OF REFERENCE SIGNS

1 housing part
2 frame structure
3 transverse support
4 longitudinal support
5 structural element
6 structural element
7 structural element
8 arrow
9 attachment point
10 attachment point
11 cell module
12 deformation region
14 wall region
15 wall region
16 connecting wall region
17 wall assembly
18 clearance

1.-8. (canceled)

9. A part of a battery housing of a motor vehicle, comprising:
a structural element arranged at an end region of the battery housing in a longitudinal direction of the motor vehicle, wherein
the structural element has at least one deformation region for targeted deformation and energy absorption, and
the deformation region has at least two interconnected wall regions which extend in a vertical direction of the motor vehicle and in a transverse direction of the motor vehicle, and between which a clearance is formed.

10. The part according to claim 9, wherein
the clearance is open toward a lower side or an upper side of the structural element.

11. The part according to claim 9, further comprising:
a plurality of ribs or similar supporting elements provided in the clearance by which the at least two interconnected wall regions extending in the vertical direction of the vehicle and in the transverse direction of the vehicle are supported in the longitudinal direction of the vehicle.

12. The part according to claim 9, wherein
the at least two interconnected wall regions extending in the vertical direction of the vehicle and in the transverse direction of the vehicle are interconnected via a connecting wall region to form a cross-sectionally substantially U-shaped wall assembly.

13. The part according to claim 9, wherein
at least one further wall region extending in the vertical direction of the vehicle and in the transverse direction of the vehicle is provided, which, together with an adjacent one of the at least two interconnected wall regions extending in the vertical direction of the vehicle and in the transverse direction of the vehicle, forms a respective further clearance.

14. The part according to claim 13, wherein
the at least one further wall region extending in the vertical direction of the vehicle and in the transverse direction of the vehicle is connected to the adjacent one of the at least two interconnected wall regions extending in the vertical direction of the vehicle and in the transverse direction of the vehicle via a connecting wall region to form a cross-sectionally substantially U-shaped wall assembly.

15. The element according to claim 9, wherein
the at least two interconnected wall regions extending in the vertical direction of the vehicle and in the transverse direction of the vehicle extend over an entire width of the structural element.

16. The element according to claim 9, wherein
the structural element is a metal cast component.
